(19) United States
(12) Patent Application Publication
(10) Pub. No.: US 2003/0212644 A1
(43) Pub. Date: Nov. 13, 2003

(54) Method of handling bulk mailing

(76) Inventor: Graeme Alexander McLintock, Konstanz (DE)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/141,676

(22) Filed: May 9, 2002

(51) Int. Cl. G06F 17/00

(52) U.S. Cl. 705/402; 705/404

(57) ABSTRACT

A system and method for using an indicium in controlled acceptance of a mailing is disclosed. The mailing comprises one or more mailpieces and each mailpiece includes a substantially same indicium regardless of the franking value of the mailpiece. The indicium is obtained or otherwise purchased in advance of mailing and is restricted by time and location of use. The purchase may be made on-line or in person. In obtaining the indicium, the mailer provides the indicium provider with at least a number of mailpieces to be included in the mailing, type of mailpiece, type of service, and desired point of deposit. Once the mailer receives the indicium he/she prints or otherwise affixes the indicium onto the mailpiece. When the mailpiece is received at a point of deposit, the indicium is read and compared to a previously stored indicium. Where a match is found, a running total of matches and respective franking value is maintained. The franking value is determined by reading the address on the mailpiece. At the end of processing, the mailer may be presented with an invoice for the franking value. Alternatively, the mailer may purchase the indicium in advance. Where no match is found, the mailpiece is not sorted into the postal stream and revenue protection measures are implemented.

### BACKGROUND OF THE INVENTION

This invention relates to the field of bulk mailing, and in particular to the area of controlled acceptance mail processing. Large volume mailers deliver batches of mail, sometimes numbering thousands of mailpieces (e.g. telephone bills) in a single delivery, to a mail sorting facility of a postal service or other mail carrier.

Typically, the mailpieces in a batch mailing are in envelopes that have been pre-printed with the mailers contract identifier (“contract” or “prepaid” mail). This contract identifier must be obtained from the mail carrier prior to manufacturing the mail batch. The mailpieces are often pre-sorted or pre-printed with barcodes to aid sortation, to speed delivery, and above all to enable the mailer to profit from mailing discounts.

As the individual mailpieces do not carry any postage related franking information, revenue protection can only be carried out during a thorough controlled acceptance procedure at the postal facility receiving the mail. This acceptance procedure is based on the mailer supplied manifest documentation (i.e. a Statement of Mailing or SoM). By sampling and checking individual mailpieces, and by weighing the batch, the number of mailpieces is estimated to allow corroboration of the billing information specified by the mailer in the SoM. This, of course, allows the possibility of collusion involving, for example, the mixing of different mail types and weights, or carrier service types within a batch declared to be uniform.

Batch mailings can also be franked individually (i.e. non-contract mail) prior to mailing using a metering machine. Metering machines are traditionally closed, secure devices that reliably imprint a postage indicium onto a mailpiece and simultaneously deduct the amount from a pre-purchased value of postage stored in a secure vault.

Many new developments in metering technology have led to open metering systems capable of creating secure manifest files recording key information about the individual indicia printed on the mailpieces (U.S. Pat. No. 6,157,919). The manifest data contains either the unique individual data stored in the indicium of each mailpiece (U.S. Pat. No. 5,768,132), or a dynamic encryption key used to create the individual indicia imprinted on the mailpieces of a batch (U.S. Pat. No. 6,073,125). The aim of these developments in metering technology has been to create a secure manifest file (i.e. Statement of Mailing) and to communicate this SoM securely to the postal facility (U.S. Pat. No. 6,009,416) accepting a mailing. Also, to avoid misuse based on a falsely created SoM, or by associating an incorrect SoM with a batch mailing, software identifiers and mailpiece identifiers encrypted into indicia imprinted on the mailpieces have been suggested (U.S. Pat. No. 6,009,416).

While the open metering systems are more flexible, particularly with regard to refunding non-used postage (U.S. Pat. No. 6,285,990), and while replacing “contract” mail with “metermark” mail would improve revenue protection, the need for numerous metering systems (typically one per customer) would be expensive.

A related field has emerged within the last decade: remote metering based on electronic stamps (U.S. Pat. No. 6,249,777). Remote metering avoids the high costs involved with the rent, lease or purchase of metering machines by using a single open metering system allowing registered customers to purchase postage via a network, e.g. the internet, and manage and expend the purchased postage using client software and a PC or a handheld client device or even a mobile telephone.

Remote metering systems require revenue protection during the mail sorting process as no controlled acceptance procedure is performed. This can require modifications to the OCR, barcode, and indicia reading systems that identify mailpiece information during sortation to allow the correctness of postage indicia to be determined.

The indicia used in meter marked and electronically stamped mail is mailpiece unique and may contain mailpiece specific data. It can be advantageous to use a revenue checking system, which does not rely on the distribution of all mailpiece indicia to every sorting facility that may encounter the mailpieces. This is possible with a self-checking stamp code, i.e. indicium, which may even be corroborated against mailpiece specific data, e.g. the destination address.

### BRIEF SUMMARY OF THE INVENTION

The revenue protection used for “contract”, or “PrePaid” mail batches can be improved. Such improvements have, in the prior art, been based on extending the application of metering machines to a type of mail by basing the billing of a customer on the manifest data collected by a sophisticated metering machine (U.S. Pat. No. 5,675,650). However, as many mail carriers have already introduced, or are currently in the process of introducing remote metering or electronic stamp systems, application of such extensions become limited. It is, therefore, an object of the present invention to provide a method of adapting the technology made available by a remote metering system to the requirements of bulk mailing, thereby providing the benefit of improved revenue protection, while avoiding the expense of individual meter machines. To achieve this and other objects according to a method of this invention, a second type of indicium, or batch mail indicium, is introduced into a remote metering system. The batch mail indicium shall be mail batch and mailer specific, allowing, in association with SoM data gathered during the controlled acceptance of the mail batch, the identification of the mail batch, the mailer, and the postage franking value associated with each mailpiece. Unlike the standard mailpiece indicia for non-batch mailpieces, which are unique to a single mailpiece, the batch mail indicia shall be acceptable on numerous mailpieces, and indeed shall be required to be identical on all mailpieces belonging to a single batch.

According to the present method, it is possible to check the quantity of mailpieces and franking value of mailpieces in a batch, and therefore to check the reliability of the SoM data and the mailer providing it. During the initial mail processing stage, the validity of the indicium on each mailpiece will be checked and the billing information for a batch accurately determined by identifying the mailpieces belonging to a batch, and by accumulating the total number of mailpieces in each mail batch. This information together with any information about the mailpieces (e.g. destination address) deemed suitable to allow checking of the franking value declared in the Statement of Mailing (i.e. manifest documentation) associated with a mail batch can also be stored to allow the reliability of mailers to later be investigated.

A further object of the present invention is to allow improved controlled acceptance of mail batches by requiring a large volume mailer to implicitly pre-announce the delivery of mail batches to a postal facility when obtaining a batch mail indicium for a batch. During acceptance of a mail batch, the validity of the batch mail indicia on one or more sample mailpieces will be checked against those of mail batches pre-announced for that particular time, at that particular sorting facility, and for the mailer delivering the mail batch. Checking the indicia against a list of previously accepted mail batch manifest data in this manner not only hastens the controlled acceptance but also ensures that the mail batch will be correctly processed during sortation.

To detect the misuse of batch mail indicia in non-batch mail, the indicia used in batch mail must be of an identifiable type. Indicia for low volume mail can then be checked for revenue infringements according to the known methods. Batch mail, on the other hand, can be checked against a list of valid batch mail indicia for the point in time in question as well as at a particular sorting facility.

Misuse of batch mail indicia in subsequent mail batches may be detected by only accepting valid batch mail indicia for a short period of time, e.g. 24 hours, after the initial processing of the batch took place.

### BRIEF DESCRIPTION OF THE SEVERAL VIEWS OF THE DRAWING

Some of the features, advantages, and benefits of the present invention having been stated, others will become apparent as the description proceeds when taken in conjunction with the accompanying drawings wherein corresponding elements are denoted by like numerals:

FIG. 1 depicts a flowchart of ordering a large volume stampcode;

FIG. 2 depicts a flowchart of acceptance of a batch mail delivery; and

FIG. 3 depicts an online processing of a mailpiece.

### DETAILED DESCRIPTION OF THE INVENTION

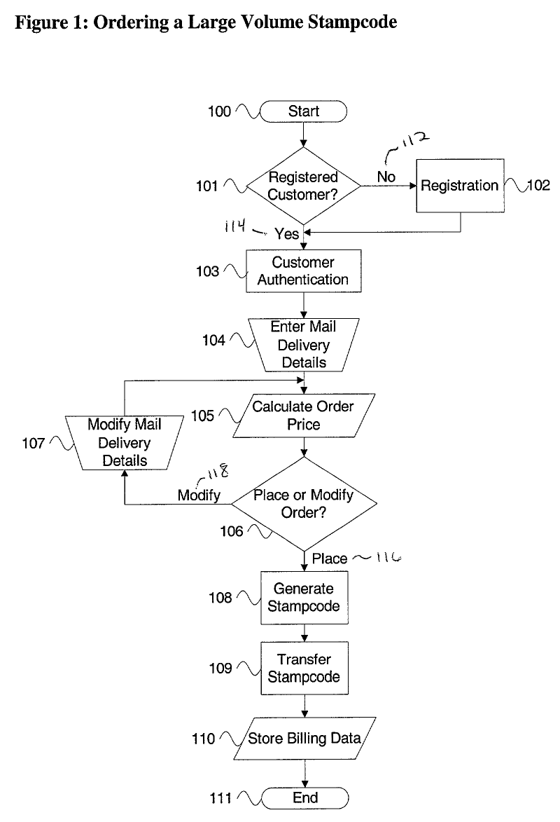

Prior to each delivery of mail to a mail sorting center, the large volume customer orders a postage stampcode, or indicium, for use on a mail piece to be posted. However, the large volume customer can only order postage after having been registered and enabled to do so by a particular postal organization. Therefore, the process of ordering postage, as depicted in FIG. 1, starts at step 100, and begins with a determination of whether the customer is registered at the postal organization 101. If the customer is not registered, 112, a registration procedure 102 is undertaken. The registration procedure may comprise an application and acceptance process, electronic or manual, as known in the art. If the customer is registered 114, the processes continues to the authentication step 103. Should the ordering of postage be carried out through an electronic online system, e.g. internet website, then the customer proceeds by authenticating him/herself to the ordering system via a password, digital signature or the like and if a paper based embodiment is employed, the authentication would similarly require signature based authentication and the like. The customer then specifies certain details about the mail to be posted 104. This mail delivery data may include:

the estimated number of mailpieces,

the mail sorting center receiving the mail delivery (Point of Postage),

the mail class (e.g. quality of service, pre-sorting, bar-coded),

estimated date and time of delivery to Point of Postage, and

mail type, as classified by the dimensions or weight.

Based on, for example, the above information, the estimated cost of posting the mail batch can be calculated 105. The customer is queried as to whether the estimated cost is acceptable for purchase 106. If the estimated cost is acceptable to the customer, he or she places the order 116. The order is confirmed, the stampcode for the mail delivery is generated and the order manifest data is stored 108. If the estimated cost and order is unacceptable to the customer and needs to be modified 118, the order is modified according to more desirable details 107. More desirable details may include different delivery date and time as well as class or volume of mail. Likewise, a postal organization may take this opportunity to offers sales and/or other specials to entice additional business. Through this selectivity, the customer is able to tailor the purchase and use of postage, delivery options and other postal resources to personal benefit. After modification of order, the cost of purchase is recalculated 105. The customer is again queried about whether the current conditions are acceptable and so one. After generation, the stampcode is transferred to the customer 109. The transfer may be electronic or manual depending upon the order format. With stampcode in hand, the customer can have the mail produced with the appropriate stampcode marked on the mailpieces. To have the mail delivered for the agreed price the customer must deliver the mail to the PoP (Point of Postage) sorting center at the specified date and time. The data specified during the ordering of postage is stored together with the generated stampcode for revenue protection and billing purposes 110 to be carried out as described below. The ordering process then ends 111.

The stampcode can take on many forms dependent upon: the particulars of the remote metering system, assurance of revenue protection methods introduced with remote metering, compliance with modifications to mail sorting systems, etc. The stampcode may comprise:

1-dimensional barcode,

2-dimensional barcode,

alphanumerical text string, and/or

some uniquely identifiable digital image, e.g. containing a fingerprint.

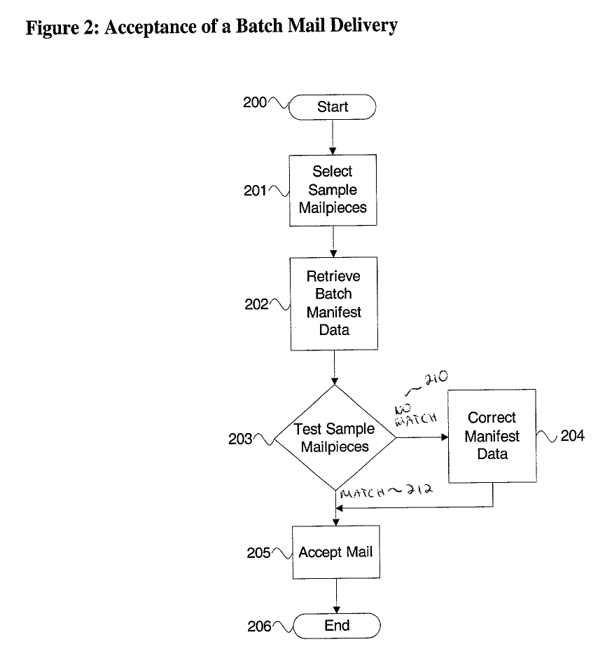

The process of controlled acceptance according to the method of this invention is shown in FIG. 2. The method starts at step 200 and proceeds. When a batch mailing is delivered to a postal sorting facility, some sample mailpieces are extracted 201 from the batch. Using a scanner or other appropriate electronic reading means, the stampcode data is extracted or otherwise read from the sample mailpieces. Alternatively, if human readable indicia are used in the remote metering system embodiment, the data is simply read from the mailpieces manually. The manifest data delivered to the mail carrier with the stampcode order 108 is retrieved from the data store of all batch manifest information 202. Next, the data derived from the sample mailpieces is tested 203 to ensure compliance with the manifest data for the batch. Should the manifest data not concur with the mailpieces sampled (210), then the manifest data may be altered to reflect a true description of the mail batch 204, e.g. correct delivery time or mailpiece weight. On agreement between the batch manifest data and the mailpieces 212 and in acceptance of the billing conditions by the mail carrier and the mailer, the mail batch is entered into the mail sorting process 205. The process returns to start if other mail pieces are to be processed, and otherwise, ends 206.

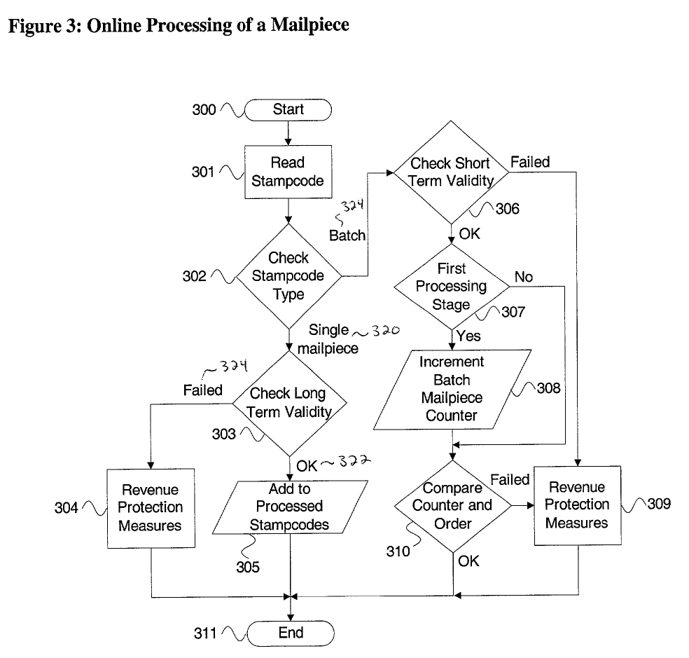

FIG. 3 shows the process to be carried out as each mailpiece is sorted. During transportation through a mail sorting machine, the stampcode is read 301, i.e. scanned, recognized and interpreted, to reproduce the stampcode data stored in the revenue protection system 110. The data read from the mailpiece is then analyzed to determine the type of stampcode. Non-large volume 320, i.e. non-batch, stampcodes, are only used singularly and are checked for validity 303 to ensure that the stampcode:

is a genuine stampcode,

has been purchased, and

has not yet been processed, i.e. not previously used on a mailpiece.

Should a stampcode not satisfy these conditions 324, then revenue protection measures can be taken 304, such as rejecting or marking the mailpiece and/or storing mailpiece data or images for review by an operator. If the stampcode is valid 322, the valid stampcodes are stored in a database 305 of processed stampcodes to enable revenue protection in the future. The process then ends or returns to start of other mail pieces are to be analyzed.

For large volume stampcodes 324, the process is somewhat different. The validity checks carried out 306 ensure that the stampcode:

is a genuine stampcode,

has been purchased, and

is part of a valid batch mailing still being processed within the allowable time window since the first mailpiece of that delivery was encountered.

During the initial processing stage 307 for each mailpiece the total number of mailpieces processed as part of the mail batch is incremented and recorded in a data store 308. The total number of mailpieces processed as part of the mail delivery is checked 310 to ensure that it has not exceeded the scheduled number of mailpieces by an excessive amount, i.e. a certain inaccuracy in the estimated number of mailpieces should be tolerated. Should a large volume mailpiece fail to satisfy these conditions then similar revenue protection measures similar to those for single mailpieces are carried out 309. Revenue protection for large volume mail can be reviewed and using the mailpiece data gathered in step 309 (e.g. destination address) the postal organization can clarify any misuse, particularly that recurring with the batch indicia of a particular large volume mailer.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

I claim:

1. A method of mailing at least one mailpiece by a mailer comprising the steps of:
obtaining an indicium from an indicium source, said indicium having a finite period of valid use and a predetermined point of deposit into a postal stream,
applying said indicium to each of said at least one mailpiece regardless of franking value of each of said at least one mailpiece, such that each of said at least one mailpiece includes an essentially identical indicium, and
delivering said at least one mailpiece to said point of deposit for sorting into said postal system, said delivering occurring within said finite period.

2. The method according to claim 1, further comprising the step of providing said indicium source with a manifest comprising data detailing a total number and franking value of said each of said at least one mailpiece, and wherein said finite period is twenty four hours.

3. The method according to claim 1, wherein said indicium comprises a two dimensional bar code.

4. The method according to claim 1, wherein said indicium comprises a three dimensional bar code.

5. The method according to claim 1, wherein said indicium comprises a digital image.

6. The method according to claim 1, wherein said step of obtaining further comprises the step of effecting an on-line purchase.

7. The method according to claim 1, wherein said step of obtaining further comprises the steps of:
providing to said indicium source:
an anticipated number of mailpieces comprising said at least one mailpiece,
type of mail which said anticipated number of mailpieces comprise; and
required postal carrier service, and
receiving from said indicium source, data related to franking value required for mailing of said anticipated number of mailpieces.

8. A method of providing indicium to a mailer for use in a mailing by said mailer, comprising the steps of:
receiving a request for an indicium, said request comprising:
at least an estimate number of mailpieces comprised in said mailing,
point of deposit of said mailing into a postal stream,
type of mail comprised by said number of mailpieces, and
type of service desired for said number of mailpieces,
offering said mailer:
an indicium for said mailing, said indicium having a finite period of valid use and restricted to said point of deposit;
a cost estimate for said indicium, said cost estimate comprising franking value of said number of mailpieces; and
conveying said indicium to said mailer upon mailer acceptance of said cost estimate, and
storing in a database said indicium after conveying said indicium to said mailer, said database accessible to said point of deposit.

9. The method according to claim 8, wherein said indicium is removed from said database after said mailing has been sorted.

10. The method according to claim 8, wherein said mailing comprises a single mailpiece.

11. The method according to claim 8, wherein said finite period is twenty four hours.

12. The method according to claim 8, wherein said indicium comprises a two dimensional bar code.

13. The method according to claim 8, wherein said indicium comprises a three dimensional bar code.

14. The method according to claim 8, wherein said indicium comprises a digital image.

15. The method according to claim 8, wherein said providing is performed on-line.

16. A method of controlled acceptance at a postal facility of mail from a mailer, comprising the steps of:
receiving a mailing comprising at least one mailpiece, said at least one mailpiece further comprising an indicium thereon, said indicium having an unexpired finite period of validity and a point of deposit comprising said postal facility,
reading said indicium,
comparing read indicium with prestored database indicium,
reading a destination address of said at least one mailpiece,
determining a franking value for said at least one mailpiece and comparing said franking value to a manifest franking value,
if a match exists between said read indicium and said database indicium and said franking value and said manifest value, sorting said mailpiece into a postal system, and
if a match does not exist between said read indicium and said database indicium or between said franking value and said manifest franking value, executing revenue protection measures.

17. The method according to claim 16, wherein if a match exists between said read indicium and said database indicium, further performing the steps of:
maintaining a running total of matches;
determining and maintaining a running total of franking value of said at least one mailpiece;
comparing said running total of matches and franking value with a manifest detailing purchase of said indicium by said mailer; and
billing said mailer for said running total of said franking value.

18. The method according to claim 16, wherein said reading is performed electronically and wherein said step of comparing further comprises the step of comparing said mailer with a database stored mailer.

19. The method according to claim 16, wherein said finite period of time is twenty four hours.

20. The method according to claim 16, wherein said indicium is acceptable only at said postal facility.

21. The method according to claim 16, wherein said indicium comprises a two dimensional bar code.

22. The method according to claim 16, wherein said indicium comprises a three dimensional bar code.

23. The method according to claim 16, wherein said indicium comprises a digital image.

24. The method according to claim 16, wherein said mail comprises a plurality of mail pieces and said indicium is substantially identical on each of said plurality of mailpieces.

25. The method according to claim 16, wherein said indicium is provided to said mailer as part of an on-line transaction.
